(19) United States
(12) Patent Application Publication
(10) Pub. No.: US 2022/0414432 A1
(43) Pub. Date: Dec. 29, 2022

(54) METHOD AND SYSTEM FOR SPLITTING AND BIT-WIDTH ASSIGNMENT OF DEEP LEARNING MODELS FOR INFERENCE ON DISTRIBUTED SYSTEMS

(71) Applicants: Amin BANITALEBI DEHKORDI, Vancouver (CA); Naveen VEDULA, Markham (CA); Yong ZHANG, Richmond (CA); Lanjun WANG, Markham (CA)

(72) Inventors: Amin BANITALEBI DEHKORDI, Vancouver (CA); Naveen VEDULA, Markham (CA); Yong ZHANG, Richmond (CA); Lanjun WANG, Markham (CA)

(21) Appl. No.: 17/902,632

(22) Filed: Sep. 2, 2022

Related U.S. Application Data
(63) Continuation of application No. PCT/CA2021/050301, filed on Mar. 5, 2021.
(60) Provisional application No. 62/985,540, filed on Mar. 5, 2020.

(51) Int. Cl. G06N 3/04; G06K 9/62

(52) U.S. Cl. CPC G06N 3/0454; G06K 9/6228; G06K 9/6262

(57) ABSTRACT

System and method for splitting a trained neural network into a first neural network for execution on a first device and a second neural network for execution on a second device. The splitting is performed to optimize, within an accuracy constraint, an overall latency of: the execution of the first neural network on the first device to generate a feature map output based on input data, transmission of the feature map output from the first device to the second device, and execution of the second neural network on the second device to generate an inference output based on the feature map output from the first device.

### RELATED APPLICATIONS

This Application is a continuation of International Patent Application No. PCT/CA2021/050301, filed Mar. 5, 2021, and claims the benefit of and priority to U.S. Provisional Patent Application No. 62/985,540 filed Mar. 5, 2020, entitled SECURE END-TO-END MIXED-PRECISION SEPARABLE NEURAL NETWORKS FOR DISTRIBUTED INFERENCE. The contents of these applications are incorporated herein by reference.

### FIELD

The present disclosure relates to artificial intelligence and distributed computing, specifically methods and systems for splitting and bit-width assignment of deep learning models for inference on distributed systems.

### BACKGROUND

The proliferation of edge devices, advances in communications systems, and advances in processing systems are driving the creation of huge amounts of data and the need for large-scale deep learning models to process such data. Large deep learning models are typically hosted on powerful computing platforms (e.g., servers, clusters of servers, and associated databases) that are accessible through the Internet. In this disclosure, “cloud” can refer to one or more computing platforms that are accessed over the Internet, and the software and databases that run on the computing platform. The cloud can have extensive computational power made possible by multiple powerful processing units and large amounts of memory and data storage. At the same time, data collection is often distributed at the edge of the cloud, that is, edge devices that are connected at the periphery of to the cloud via the Internet, such as smart-home cameras, authorization entry devices (e.g., license plate recognition camera), smart-phone and smart-watches, surveillance cameras, medical devices (e.g., hearing aids, and personal health and fitness trackers), and Internet of Things (IoT) devices. The combination of powerful deep learning models and abundant data are driving progress of AI applications.

However, the gap between huge amounts of data and large deep learning models remains and becomes a more and more arduous challenge for more extensive AI applications. Exchanging data and the resulting inference results of deep learning models between edge devices and the cloud is far from straightforward. Large deep learning models cannot be loaded onto edge devices due to their very limited computation capability (e.g., edge devices tend to have limited processing capability, limited memory and storage capability and limited power supply). Indeed, deep learning models are becoming more and more powerful and larger and larger and more impractical for edge devices. Recent large deep learning models that are now being introduced are even incapable of being supported by a single cloud server—such deep learning models require cloud clusters.

Uploading data from edge devices to the cloud is not always desirable or even feasible. Transmitting high resolution, high volume input data to the cloud may incur high transmission latency, and may result in high end-to-end latency for an AI application. Moreover, when high resolution, high volume input data is transmitted to the cloud, additional privacy risks may be imposed.

In general, edge-cloud data collection and processing solutions fall within three categories: (1) EDGE-ONLY; (2) CLOUD-ONLY; and (3) EDGE-CLOUD collaboration. In the EDGE-ONLY solution, all data collection and data processing functions are performed at the edge device. Model compression techniques are applied to force-fit an entire AI application that includes one or more deep learning models on edge devices. In many AI applications, the EDGE-ONLY solution may suffer from serious accuracy loss. The CLOUD-ONLY solution is a distributed solution where data is collected and may be preprocessed at the edge device but is transmitted to the cloud for inference processing by one or more deep learning models of an AI application. CLOUD-ONLY solutions can incur high data transmission latency, especially in the case of high resolution data for high-accuracy AI applications. Additionally, CLOUD-ONLY solutions can give rise to data privacy concerns.

In EDGE-CLOUD collaboration solutions, a software program that implements a deep learning model which performs a particular inference task can be broken into multiple programs that implement smaller deep learning models to perform the particular inference task. Some of these smaller software programs can run on edge devices and the rest run on the cloud. The outputs generated by the smaller deep learning models running on the edge device are sent to the cloud for further processing by the rest of smaller deep learning models running on the cloud.

One example of an EDGE-CLOUD collaboration solutions is a cascaded edge-cloud inference approach that divides a task into multiple sub-tasks, deploys some sub-tasks on the edge device and transmits the output of those tasks to the cloud where the other tasks are run. Another example is a multi-exit solution, which deploys a lightweight model on the edge device (e.g. a compressed deep learning model) for processing simpler cases, and transmits the more difficult cases to a larger deep learning model implemented on the cloud. The cascaded edge-cloud inference approach and the multi-exit solution are application specific, and thus are not flexible for many use cases. Multi-exit solutions may also suffer from low accuracy and have non-deterministic latency.

A flexible solution that enables edge-cloud collaboration is desired, including a solution that enables deep learning models to be partitioned between asymmetrical computing systems (e.g., between an edge device and the cloud) so that the end-to-end latency of an AI application can be minimized and the deep learning model can be asymmetrically implemented on the two computing systems. Moreover, the solution should be general and flexible so that it can be applied to many different tasks and deep learning models.

### SUMMARY

According to a first aspect, a method is disclosed for splitting a trained neural network into a first neural network for execution on a first device and a second neural network for execution on a second device. The method includes: identifying a first set of one or more neural network layers from the trained neural network for inclusion in the first neural network and a second set of one or more neural network layers from the trained neural network for inclusion in the second neural network; and assigning weight bit-widths for weights that configure the first set of one or more neural network layers and feature map bit-widths for feature maps that are generated by the first set of one or more neural network layers. The identifying and the assigning are being performed to optimize, within an accuracy constraint, an overall latency of: the execution of the first neural network on the first device to generate a feature map output based on input data, transmission of the feature map output from the first device to the second device, and execution of the second neural network on the second device to generate an inference output based on the feature map output from the first device.

Such a solution can enable the inference task of a neural network to be distributed across multiple computing platforms, including computer platforms that have different computation abilities, in an efficient manner.

In some aspects of the method, the identifying and the assigning may include: selecting, from among a plurality of potential splitting solutions for splitting the trained neural network into the first set of one or more neural network layers and the second set of one or more neural network layers, a set of one or more feasible solutions that fall within the accuracy constraint, wherein each feasible solution identifies: (i) a splitting point that indicates the layers from the trained neural network that are to be included in the first set of one or more layers; (ii) a set of weight bit-widths for the weights that configure the first set of one or more neural network layers; and (iii) a set of feature map bit-widths for the feature maps that are generated by the first set of one or more neural network layers.

In one or more of the preceding aspects, the method may include selecting a implementation solution from the set of one or more feasible solutions; generating, in accordance with the implementation solution, first neural network configuration information that defines the first neural network and second neural network configuration information that defines the second neural network; and providing the first neural network configuration information to the first device and the first second neural network configuration information to the second device.

In one or more of the preceding aspects, the selecting may be further based on a memory constraint for the first device.

In one or more of the preceding aspects, the method may include, prior to the selecting the set of one or more feasible solutions, determining the plurality of potential splitting solutions is based on identifying transmission costs associated with different possible splitting points that are lower than a transmission cost associated with having all layers of the trained neural network included in the second neural network.

In one or more of the preceding aspects, the selecting may comprise: computing quantization errors for the combined performance of the first neural network and the second neural network for different weight bit-widths and feature map bit-widths for each of the plurality of potential solutions, wherein the selecting the set of one or more feasible solutions is based on selecting weight bit-widths and feature map bit-widths that result in computed quantization errors that fall within the accuracy constraint.

In one or more of the preceding aspects, the different weight bit-widths and feature map bit-widths for each of the plurality of potential solutions may be uniformly selected from sets of possible weight bit-widths and feature map bit-widths, respectively.

In one or more of the preceding aspects, the accuracy constraint may comprise a defined accuracy drop tolerance threshold for combined performance of the first neural network and the second neural network relative to performance of the trained neural network.

In one or more of the preceding aspects, the first device may have lower memory capabilities than the second device.

In one or more of the preceding aspects, the first device is an edge device and the second device is a cloud based computing platform.

In one or more of the preceding aspects, the trained neural network is an optimized trained neural network represented as a directed acyclic graph.

In one or more of the preceding aspects, the first neural network is a mixed-precision network comprising at least some layers that have different weight and feature map bit-widths than other layers.

According to a further example aspect, a computer system is disclosed that comprises one or more processing devices and one or more non-transient storages storing computer implementable instructions for execution by the one or more processing devices, wherein execution of the computer implementable instructions configures the computer system to perform the method of any one of the preceding aspects.

According to a further example aspect, a non-transient computer readable medium is disclosed that stores computer implementable instructions that configure a computer system to perform the method of any one of the preceding aspects.

### BRIEF DESCRIPTION OF THE DRAWINGS

Reference will now be made, by way of example, to the accompanying drawings, which show example embodiments of the present application, and in which:

FIG. 1 is a block diagram of a distributed environment in which systems and methods described herein can be applied;

FIG. 2 is a block diagram of an artificial intelligence model splitting module according to examples of the present disclosure;

FIG. 3 is a process flow diagram illustrating actions performed by an operation for generating a list of potential splitting solutions that is part of the artificial intelligence model splitting module of FIG. 2;

FIG. 4 is a pseudocode representation of the actions of FIG. 3, followed by further actions performed by an optimized solution selection operation of the artificial intelligence model splitting module of FIG. 2;

FIG. 5 is a block diagram of an example processing system that may be used to implement examples described herein;

FIG. 6 is a block diagram illustrating an example hardware structure of a NN processor, in accordance with an example embodiment;

FIG. 7 is a block diagram illustrating a further example of a neural network partitioning system according to the present disclosure;

FIG. 8 illustrates an example of partitioning according to the system of FIG. 7;

FIG. 9 is a pseudocode representation of a method performed in accordance with the system of FIG. 7.

FIG. 10 illustrates an example of a practical application of the method of the present disclosure.

Similar reference numerals may have been used in different figures to denote similar components.

### DESCRIPTION OF EXAMPLE EMBODIMENTS

Example solutions for collaborative processing of data using distributed deep learning models are disclosed. The collaborative solutions disclosed herein can be applied to different types of multi-platform computing environments, including environments in which deep learning models for performing inference tasks are divided between asymmetrical computing platforms, including for example between a first computing platform and a second computing platform that has much higher computational power and abilities than the first computing platform.

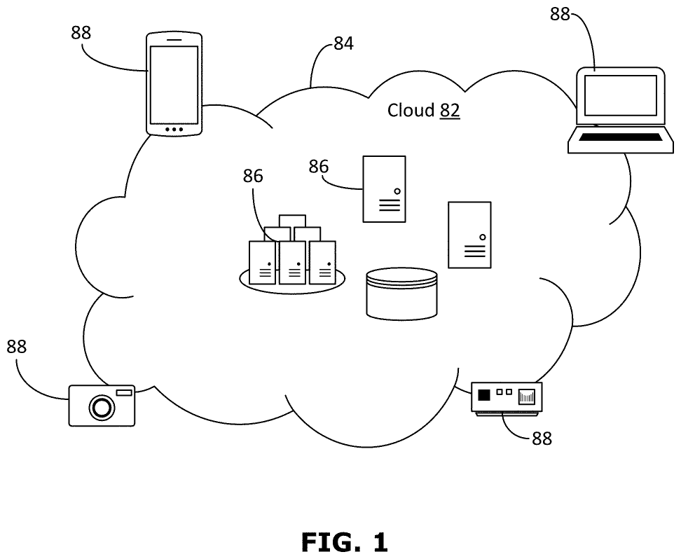

With reference to FIG. 1, methods and systems are illustrated in the context of first computing platform that is an edge device 88 and a second computing platform that is a cloud computing platform 86 that is part of the cloud 82. In particular, the cloud 82 includes a plurality of cloud computing platforms 86 that are accessible by edge devices 88 through a network 84 that includes the Internet. Cloud computing platforms 86 can include powerful computer systems (e.g., cloud servers, clusters of cloud servers (cloud clusters), and associated databases) that are accessible through the Internet. Cloud computing platforms 86 can have extensive computational power made possible by multiple powerful and/or specialized processing units and large amounts of memory and data storage. Edge devices 88 are distributed at the edge of cloud 82 and can include, among other things, smart-phones, personal computers, smart-home cameras and appliances, authorization entry devices (e.g., license plate recognition camera), smart-watches, surveillance cameras, medical devices (e.g., hearing aids, and personal health and fitness trackers), various smart sensors and monitoring devices, and Internet of Things (IoT) nodes.

An edge-cloud collaborative solution is disclosed that exploits the fact that amount of data being that is processed at some intermediate layer of a deep learning model (otherwise known as a deep neural network model (DNN for short)) is significantly less than that of raw input data to the DNN. This reduction in data enables a DNN to be partitioned (i.e. split) into an edge DNN and a cloud DNN, thereby reducing transmission latency and lowering end-to-end latency of an AI application that includes the DNN, as well as adding an element of privacy to data that that is uploaded to the cloud. In at least some examples, the disclosed edge-cloud collaborative solution is generic, and can be applied to a large number of AI applications.

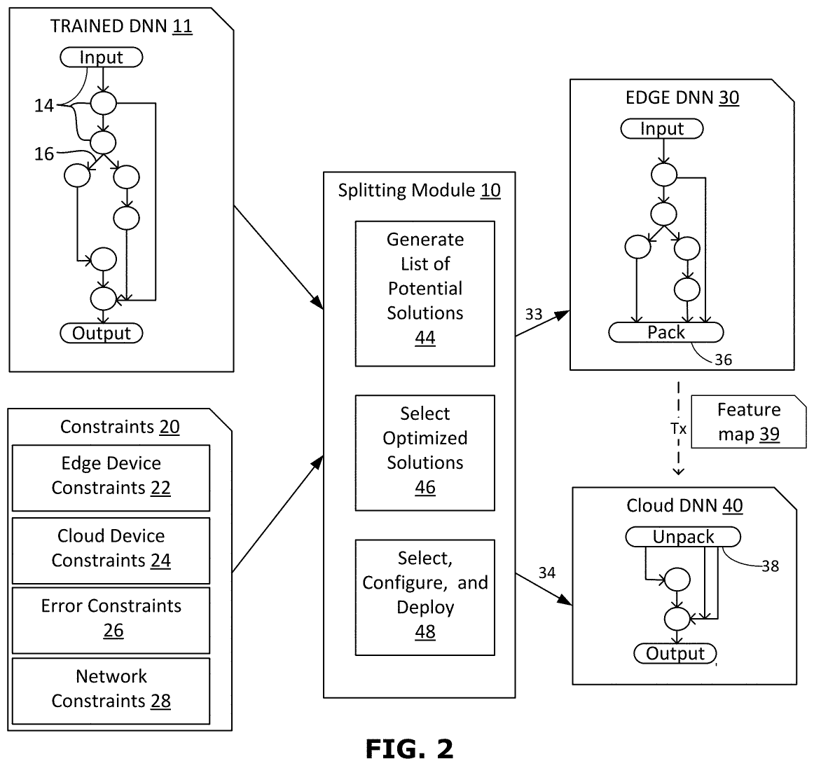

In this regard, FIG. 2 is a block diagram representation of a system that can be applied to enable an edge-cloud collaborative solution according examples of the present disclosure. An deep learning model splitting module 10 (hereinafter splitting module 10) is configured to receive, as an input a trained deep learning model for an inference task, and automatically process the trained deep learning model to divide (i.e. split) it into first and second deep learning models that can be respectively implemented on a first computing platform (e.g., an edge device 88) and a second computing platform (e.g., a cloud computing platform 86 such as a cloud server or cloud cluster, hereinafter referred to as a “cloud device” 86). As used here, a “module” can refer to a combination of a hardware processing circuit and machine-readable instructions (software and/or firmware) executable on the hardware processing circuit. A hardware processing circuit can include any or some combination of a microprocessor, a core of a multi-core microprocessor, a microcontroller, a programmable integrated circuit, a programmable gate array, a digital signal processor, or another hardware processing circuit. In some examples, splitting module 10 may be hosted on a cloud computing platform 86 that is configured to provide edge-cloud collaborative solutions as a service. In some examples, splitting module 10 may be hosted on a computing platform that is part of a proprietary enterprise network.

In the example of FIG. 2, the deep learning model that is provided as input to the splitting module 10 is a trained DNN 11, and the resulting first and second deep learning models that are generated by the splitting module 10 are an edge DNN 30 that is configured to for deployment on a target edge device 88 and a cloud DNN 40 that is configured for deployment on a target cloud device 86. As will be explained in greater detail below, splitting module 10 is configured to divide the trained DNN 11 into edge DNN 30 and cloud DNN 40 based on a set of constraints 20 that are received by the splitting module 10 as inputs. These constrains may include, for example: (i) Edge device constraints 22: one or more parameters that define the computational abilities (e.g., memory size, CPU bit processing size) of the target edge device 88 that will be used to implement the edge DNN 30. These can include explicit parameters such as memory size, bit-width supported by processor, etc.; (ii) Cloud device constraints 24: one or more parameters that define the computational abilities of the target cloud device 86 that will be used to implement the cloud DNN 40; (iii) Error constraints 26: one or more parameters that specify an inference error tolerance threshold; (iv) Network constraints 28: one or more parameters that specify information about the communication network links that exist between the cloud device 86 and the edge device 88, including for example: one or more network types (e.g., Bluetooth, 3G-5G Cellular link, wireless local area network (WLAN) link properties); network latency, power and/or noise ratio measurements; and/or link transmission metered costs.

DNN 11 is a DNN model that has been trained for a particular inference task. DNN 11 comprises a plurality of network layers that are each configured to perform a respective computational operation to implement a respective function. By way of example, a layer can be, among other possibilities, a layer that conforms to known NN layer structures, including: (i) a fully connected layer in which a set of multiplication and summation functions are applied to all of the input values included in an input feature map to generate an output feature map of output values; (ii) a convolution layer in which a multiplication and summation function is applied through convolution to subsets of the input values included in an input feature map to generate an output feature map of output values; (iii) a batch normalization layer that applies a normalization function across batches of multiple input feature maps to generate respective normalized output feature maps; (iv) an activation layer that applies a non-liner transformation function (e.g., a Relu function or sigmoid function) to each of the values included in an input feature map to generate an output feature map of activated values (also referred to as an activation map or activations); (v) a multiplication layer that can multiply two input feature maps to generate a single output feature map; (vi) a summation layer that sums two input feature maps to generate a single output feature map; (vii) a linear layer that is configured to apply a defined linear function to an input feature map to generate an output feature map; (viii) a pooling layer that performs an aggregating function for combing values in an input feature map into a smaller number of values in an output feature map; (ix) an input layer for the DNN which organizes an input feature map to the DNN for input to an intermediate set of hidden layers; and (x) an output layer than organizes the feature map output by the set of intermediate set of hidden layers into an output feature map for the DNN. In some examples, layers may be organized into computational blocks; for example a convolution layer, batch normalization layer and activation layer could collectively provide a convolution block.

The operation of at least some of the layers of trained DNN 11 can be configured by sets of learned weight parameters (hereafter weights). For example, the multiplication operations in multiplication and summation functions of fully connected and convolution layers can be configured to apply matrix multiplication to determine the dot product of an input feature map (or sub-sets of an input feature map) with a set of weights. In this disclosure, a feature map refers to an ordered data structure of values in which the position of the values in the data structure has a meaning. Tensors such as vectors and matrices are examples of possible feature map formats.

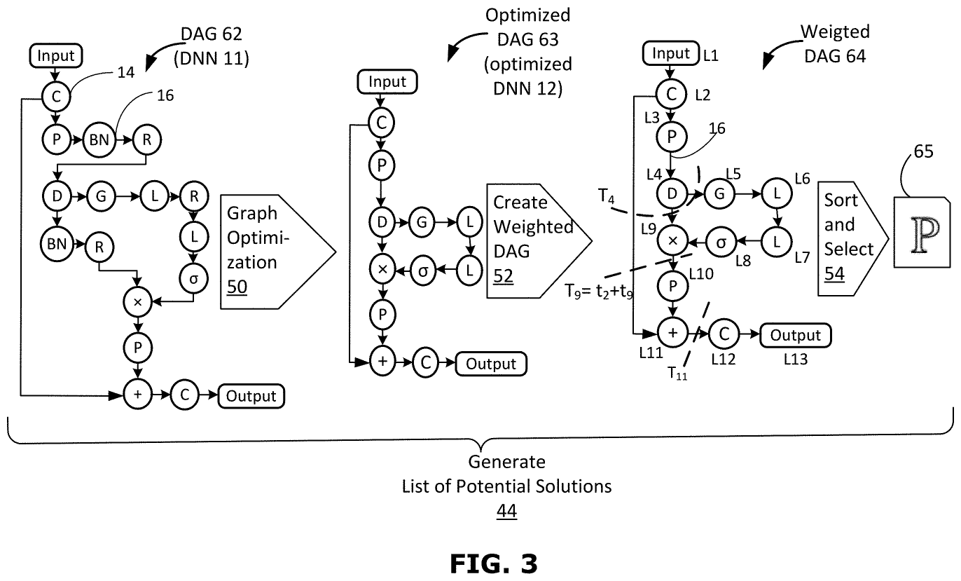

As known in the art, a DNN can be represented as a complex directed acyclic graph (DAG) that includes a set of nodes 14 that are connected by directed edges 16. An example of a DAG 62 is illustrated in greater detail in FIG. 3. Each node 14 represents a respective layer in a DNN, and has a respective node type that corresponds to the type of layer that it represents. For example, layer types can be denoted as: C-layer, representing a convolution network layer; P-layer, representing a point-convolution network layer; D-layer, representing a depth convolution network layer; L-layer, representing a miscellaneous linear network layer; G-layer, representing a global pooling network layer; BN-layer, representing a batch normalization network layer; A-layer, representing an activation layer (may include activation type, for example, R-layer for Relu activation layer and σ-node for sigmoid activation layer); a +-layer, representing a summation layer; X-layer, representing a multiplication layer; Input-layer representing an input layer; Output-layer representing an output layer. Directed edges 16 represent the directional flow of feature maps through the DNN.

Referring to FIG. 2, As will be explained in greater detail below, splitting module 10 is configured to perform a plurality of operations to generate edge DNN 30 and Cloud DNN 40, including a pre-processing operation 44 to generate a list of potential splitting solutions, a selection operation 46 to generate a final, optimized splitting solution, and a pack and deploy operation 48 that packs and deploys the resulting edge and cloud DNNs 30, 40.

In example embodiments, the division of trained DNN 11 into edge DNN 30 and cloud DNN 40 is treated as a nonlinear integer optimization problem that has an objective of minimizing overall latency given edge device constraints 22 and a user given error constraint 26, by jointly optimizing a split point for dividing the DNN 11 along with bit-widths for the weight parameters and input and output tensors for the layers that are included in the edge DNN 30.

Operation of splitting module 10 will be explained using the following variable names.

N denotes the total number of layers of an optimized trained DNN 12 (optimized DNN 12 is an optimized version of trained DNN 11, described in greater detail below), n denotes the number of layers included in the edge DNN 30 and (N-n) denotes the number of layers including in the cloud DNN 40.

s^{w} denotes a vector of sizes for the weights that configure the layers of trained DNN 12, with each value s^{w}ᵢ in the vector s^{w} denoting the number of weights for the i^{th} layer of the trained DNN 12. s^{a} denotes a vector of sizes of the output feature maps generated by the layers of a DNN 12, with each value s^{a}ᵢ in the vector s^{a} denoting the number of number of feature values included in the feature map generated by the i^{th} layer of the trained DNN 12. In example embodiments, the numbers of weights and feature values for each layer remains constant throughout the splitting process—i.e., the number s^{w}ᵢ of weights and the number of activations

s^{a}ᵢ for a particular layer i from trained DNN 12 will remain the same for the corresponding layer in whichever of edge DNN 30 or cloud DNN 40 the layer i is ultimately implemented.

b^{w} denotes a vector of bit-widths for the weights that configure the layers of a DNN, with each value b^{w}ᵢ in the vector b^{w} denoting the bit-width (e.g., number of bits) for the weights for the i^{th} layer of a DNN. b^{a} denotes a vector of bit-widths for the output feature values that are output from the layers of a DNN, with each value b^{a}ᵢ in the vector b^{a} denoting the bit-width of (i.e., number of bits) used for the feature values for the i^{th} layer of a DNN. By way of example, bit widths can be 128, 64, 32, 16, 8, 4, 2, and 1 bit(s), with each reduction in bit width corresponding to a reduction in accuracy. In example embodiments, the bit-widths for weights and output feature maps for a layer are set based on the capability of the device hosting the specific DNN layer.

L^{edge}(⋅) and L^{cloud}(⋅) denote latency functions for the edge device 88 and cloud device 86, respectively. In the case where s^{w} and s^{a} are fixed, L^{edge} and L^{cloud} are functions of the weight bit-widths and feature map value bit widths.

The latency of executing the i^{th} layer of the DNN on edge device 88 and on the cloud device 86 can be denoted by: [symbol] ᵢ^{edge}=L^{edge}(bᵢ^{w}, bᵢ^{a}) and [symbol] ᵢ^{cloud}=L^{cloud}(bᵢ^{w}, bᵢ^{a}), respectively.

L^{tr}(⋅) denotes a function that measures latency for transmitting data from the edge device 88 to cloud device 86, and [symbol] ᵢ^{tr}=L^{tr}(sᵢ^{a}×bᵢ^{a}) denotes the transmission latency for the i^{th} layer.

wⁱ(⋅) and aⁱ(⋅) denote the weight tensor and output feature map, respectively, for a given weight bit-width and feature value bit-width at an i^{th} layer.

By using the mean square error function MSE (. , .), the quantization error at the i^{th} layer for weights can be denoted as: Dᵢ^{w}=MSE(wᵢ(b_{SourceDNN(i)}^{w}), wᵢ(bᵢ^{w})), where b_{SourceDNN(i)}^{w} indicates the bit-width used in the trained DNN 12 and bᵢ^{w} indicates the bit-width for the target DNN, and the quantization error at the i^{th} layer for an output feature map can be denoted as: Dᵢ^{a}=MSE(aᵢ(b_{SourceDNN(i)}^{a}), aᵢ(bᵢ^{a})), where b_{SourceDNN(i)}^{a} indicates the bit-width used in the trained DNN 12 and bᵢ^{w} indicates the bit-width for the target DNN. MSE is a known measure for quantization error, however, other distance metrics can alternatively be used to quantity quantization error such as cross-entropy or KL-Divergence.

An objective function for the splitting module 10 can be denoted in terms of the above noted latency functions as follows: If the trained DNN 12 is split at layer n (i.e., first n layers are allocated to edge DNN 30 and the remaining N-n layers are allocated to cloud DNN 40), then an objective function can be defined by summing all the latencies for the respective layers of the edge DNN 30, the cloud DNN 40 and the intervening transmission latency between the DNNs 30 and 40, as denoted by:

$$ℒ ( {b}^{w} {b}^{a} , n ) = {\sum }_{i = 1}^{n} {ℒ}_{i}^{edge} + {ℒ}_{n}^{tr} + {\sum }_{i = n + 1}^{N} {ℒ}_{i}^{cloud} . \qquad ( 1 )$$

In equation 1, the tuple (b^{w}, b^{a}, n) represents a DNN divisional solution where n is the number of layers that are allocated to the edge NN, b^{w} is the bit-width vector for the weights for all layers, and b^{a} is the bit-width vector for the output feature maps for all layers

When n=0, all layers of the trained DNN 12 are allocated to cloud DNN 40 for execution by cloud device 86. Typically, the training device that is used to train DNN 11 and the cloud device 86 will have comparable computing resources. Accordingly, in example embodiments the original bit-widths of trained from DNN 12 are also used for cloud DNN 40, thereby avoiding any quantization error for layers that are included in cloud DNN 40. Thus, the latency [symbol] ᵢ^{cloud} for i=1, . . . , are constants. Moreover, since transmission latency [symbol] ₀^{tr} represents the time cost for transmitting raw input to cloud device 86, it can be reasonably assumed that [symbol] ₀^{tr} is a constant under a given network condition. Therefore, the objective function for the CLOUD-ONLY solution [symbol] (b^{w}, b^{a}, 0) is also a constant.

Thus, the objective function can be represented as:

$$ℒ ( {b}^{w} , {b}^{a} , n ) - ℒ ( {b}^{w} , {b}^{a} , 0 ) = ( {\sum }_{i = 1}^{n} {ℒ}_{i}^{edge} + {ℒ}_{n}^{tr} + {\sum }_{i = n + 1}^{N} {ℒ}_{i}^{cloud} ) - \\ ( {ℒ}_{0}^{tr} + {\sum }_{i = 1}^{N} {ℒ}_{i}^{cloud} ) = ( {\sum }_{i = 1}^{n} {ℒ}_{i}^{edge} + {ℒ}_{n}^{tr} ) - ( {ℒ}_{0}^{tr} + {\sum }_{i = 1}^{n} {ℒ}_{i}^{cloud} )$$

After removing the constant [symbol] ₀^{tr}, the objective function for the splitting module 10 can be denoted as:

$${\sum }_{i = 1}^{n} {ℒ}_{i}^{edge} + {ℒ}_{n}^{tr} - {\sum }_{i = 1}^{n} {ℒ}_{i}^{cloud} . \qquad ( 2 )$$

In example embodiments, constraints 20, and in particular edge device constraints 22 (e.g., memory constraints) and user specified error constraints 26 are also factors in defining a nonlinear integer optimization problem formulation for the splitting module 10. Regarding memory constraints, in typical device hardware configurations, “read-only” memory stores the parameters (weights), and “read-write” memory stores the feature maps. The weight memory cost on the edge device 88 can be denoted as [symbol] =Σᵢ₌₁ⁿ(sᵢ^{w}×bᵢ^{w}). Unlike weights, input and output feature maps only need to be partially stored in memory at a given time. Thus, the read-write memory required for feature map storage is equal to the largest working set size of the activation layers at a given time. In case of a simple DNN chain, i.e., layers stacked one by one, the largest activation layer feature map working set can be computed as [symbol] ^{a}=_{i=1, . . . , n}^{max}(sᵢ^{a}×bᵢ^{a}). However, for complex DNN DAGs, the working set needs to be determined based on the DNN DAG. By way of example, FIG. 3 shows an example of an illustrative DAG 64 generated in respect of an original trained DNN 12. When layer L4 (a depthwise convolution D-layer) is being processed, both the output feature maps of layer L2 (a convolution C-layer) and layer L3 (a pointwise convolution P-layer) need to be kept in memory. Although the output feature map of layer L2 is not required for processing layer the layer L4, it needs to be stored for future layers such as layer 11 (a summation+layer). Assuming the available memory size of the edge device 88 for executing the edge DNN 30 is M then the memory constraint can be denoted as:

[symbol]

+ [symbol] ^{a}≤M. (3)

Regarding the error constraint, in order to maintain the accuracy of the combined edge DNN 30 and cloud DNN 40, the total quantization error is constrained by a user given error tolerance threshold E. In the case where the original bit-widths from DNN 12 are also used for are the layers of cloud DNN 40, the quantization error determination can be based solely by summing the errors that occur in the edge DNN 30, denoted as:

$${\sum }_{i = 1}^{n} ( {𝒟}_{i}^{w} + {𝒟}_{i}^{a} ) \leq E . \qquad ( 4 )$$

Accordingly, in example embodiments the splitting module 10 is configured to pick a DNN splitting solution that is based on the objective function (2) along with the memory constraint (3) and the error constraint (4), which can be summarized as problem (5), which has a latency minimization component (5a), memory constraint component (5b) and error constraint component (5c):

DNN Splitting Problem (5):

$${min}_{{b}^{w} , {b}^{a} ∈ {𝔹}^{a} , n} ( {\sum }_{i = 1}^{n} {ℒ}_{i}^{edge} + {ℒ}_{n}^{tr} - {\sum }_{i = 1}^{n} {ℒ}_{i}^{cloud} ) \qquad ( 5 a )$$

$$s . t . {ℳ}^{w} + {ℳ}^{a} \leq M , \qquad ( 5 b )$$

$${\sum }_{i = 1}^{n} ( {𝒟}_{i}^{w} + {𝒟}_{i}^{a} ) \leq E , \qquad ( 5 c )$$

Where [symbol] is a candidate bit-width set for the weights and feature maps. In example embodiments, the edge device 88 has a fixed candidate bit-width set [symbol] . For example, candidate bit-width set [symbol] for edge device 88 could be set to [symbol] ={2,4,6,8}.

In examples, the latency functions (e.g., L^{edge}(⋅), L^{cloud}(⋅)) are not explicitly defined functions. Rather, simulator functions (as known in the art) can be used by splitting module 10 to obtain the latency values. Since the latency functions are not explicitly defined, and the error functions (e.g., Dᵢ^{w}, Dᵢ^{a}) are nonlinear, problem (5) is a nonlinear integer optimization function and non-deterministic polynomial-time hard (NP-hard) problem to solve. However, problem (5) does have a known feasible solution, i.e., n=0, which implies executing all layers of the DNN 12 on the cloud device 86.

As noted above, problem (5) is constrained by a user given error tolerance threshold E. Practically, it may be more tractable for a user to provide an accuracy drop tolerance threshold A, rather than an error tolerance threshold E. In addition, for a given drop tolerance threshold A, calculating the corresponding error tolerance threshold E is still intractable. As will be explained in greater detail below, splitting module 10 can be configured in example embodiments to enable a user to provide an accuracy drop tolerance threshold A and also address the intractability issue.

Furthermore, as problem (5) is NP-hard, in example embodiments splitting module 10 is configured to apply a multi-step search approach to find a list of potential solutions that satisfy memory constraint component (5b) and then select, from the list of potential solutions, a solution which minimizes the latency component (5a) and satisfies the error constraint component (5c).

In the illustrated example, splitting module 10 includes an operation 44 to generate a list [symbol] of potential solutions by determining, for each layer, the size (e.g., amount) of data that would needs to be transmitted from that layer to the subsequent layer(s). Next, for each splitting point (i.e., for each possible value of n) two sets of optimization problems are solved to generate a feasible list [symbol] of solutions that satisfy memory constraint component (5b).

In this regard, reference will be made to FIG. 3 which illustrates a three step operation 44 for generating list [symbol] of potential solutions, according to example embodiments. The input to FIG. 3 is un-optimized trained DNN 11, represented as a DAG 62 in which layers are shown as nodes 14 and relationships between the layers are indicated by directed edges 16. An initial set of graph optimization actions 50 are performed to optimize the un-optimized trained DNN 11. In particular, as known in the art, actions such as batch-norm folding and activation fusion can be performed in respect of a trained DNN to incorporate the functionality of batch-norm layers and activation layers into preceding layers to result in an optimized DAG 63 for inference purposes. As indicated in FIG. 3, optimized DAG 63 (which represents an optimized trained DNN 12 for inference purposes) does not include discrete batch normalization and Relu activation layers.

A set of weight assignment actions 52 are then performed to generate a weighted DAG 64 that includes weights assigned to each of the edges 16. In particular, the weights assigned to each edge represent lowest transmission cost tᵢ possible for that edge if the split point n is located at that edge. It will be noted that some nodes (e.g., the D-layer node that represent layer L4) will have multiple associated edges, each of which is assigned a transmission cost tᵢ. The lowest transmission cost is selected as the edge weight. A potential splitting point n should satisfy the memory constraint with the lowest bit-width assignment, bₘᵢₙ(Σᵢ₌₁ⁿsᵢ^{w}+max sᵢ^{a})≤M, where bₘᵢₙ is the lowest bit-width constrained by the edge device 88. The lowest transmission cost tᵢ for an edge is bₘᵢₙs^{a}. The lowest transmission cost Tₙ for a split point n is the sum of all the individual edge transmission costs tᵢ for the unique edges that would be cut at the split point n. For example, as shown in weighted DAG 64, at split point n=4, the transmission cost T₄ would be t₂+t₄ (note that although two edges from layer L4 are cut, the data on both edges is the same and thus only needs to be transmitted once); at split point n=9, the transmission cost T₉ would be t₂+t₉; and at split point n=11, the transmission cost T₁₁ would be t₁₁.

Sorting and selection actions 54 are then performed in respect of the weighted DAG 64. In particular, the weighted DAG 64 is sorted in topological order based on the transmission costs, a list of possible splitting points is identified, and an output 65 is generated that includes the list [symbol] of potential splitting point solutions. In example embodiments, in order to identify possible splitting points, an assumption is made that the raw data transmission cost T₀ is a constant, so that then a potential split point n should have transmission cost Tₙ<T₀ (i.e., [symbol] ₙ^{tr}≤ [symbol] ₀^{tr}). This assumption effectively assumes that there is a better solution than transmitting all raw data to the cloud device 86 and performing the entire trained DNN 12 on the cloud device 86. Accordingly, the list [symbol] of potential splitting points can be determined as:

$$ℙ = \{ n ∈ 0 , 1 , … , N \vert {T}_{n} \leq {T}_{0} , {b}_{min} ( {\sum }_{i = 1}^{n} {s}_{i}^{w} + {max}_{i = 1 , … , n} {s}_{i}^{a} ) \leq M \} . \qquad ( 6 )$$

In summary, list [symbol] of potential splitting points will include all potential splitting points that have a transmission cost that is less than the raw transmission cost T₀, where the transmission cost for each edge is constrained by the minimum bit-width assignment for edge device 88. In this regard, the list [symbol] of potential splitting points provides a filtered set of splitting points that can satisfy the memory constraint component (5b) of problem (5). Referring again to FIG. 3, the list [symbol] of potential splitting points is then provided to operation 46 that performs a set of actions to solve a sets of optimization problems to determine a list [symbol] of feasible solutions. Operation 46 is configured to, for each potential splitting point n∈ [symbol] , identify all feasible solutions which satisfy the constraints of problem (5). In example embodiments, the list [symbol] of feasible solutions is presented as a list of tuples (b^{w}, b^{a}, n).

As noted above, explicitly setting an error tolerance threshold E is intractable. Thus, to obtain feasible solutions problem (5), the operation 46 is configured to determine which of the split points n∈ [symbol] will result in weight and feature map quantization errors that will fall within a user specified accuracy drop threshold

A. In this regard, an optimization problem (7) can be denoted as:

$${min}_{{b}^{w} , {b}^{a} ∈ {𝔹}^{n}} {\sum }_{i = 1}^{n} ( {𝒟}_{i}^{w} + {𝒟}_{i}^{a} ) \qquad ( 7 a )$$

$$s . t . {ℳ}^{w} + {ℳ}^{a} \leq M , \qquad ( 7 b )$$

The splitting point solutions to optimization problem (7) that provide quantization errors that fall within the accuracy drop threshold A can be selected for inclusion in list [symbol] of feasible solutions. For given splitting point p, the search space within optimization problem (7) is exponential, i.e., | [symbol] |²ⁿ. To reduce the search space, problem (7) is decoupled into two problems (8) and (9):

$${min}_{{b}^{w} ∈ {𝔹}^{n}} {\sum }_{i = 1}^{n} {𝒟}_{i}^{w} s . t . {ℳ}^{w} \leq {M}^{wgt} , \qquad ( 8 )$$

$${min}_{{b}^{a} ∈ {𝔹}^{n}} {\sum }_{i = 1}^{n} {𝒟}_{i}^{a} s . t . {ℳ}^{a} \leq {M}^{act} , \qquad ( 9 )$$

where M^{wgt} and M^{act} are memory budgets for weights and feature maps, respectively, and M^{wgt}+M^{act}≤M. Different methods can be applied to solve problems (8) and (9), including for example the Lagrangian method proposed in: [Y. Shoham and A. Gersho. 1988. Efficient bit allocation for an arbitrary set of quantizers. IEEE Trans. Acoustics, Speech, and Signal Processing 36 (1988)].

To find feasible candidate bit-width pairs that correspond to memory budgets M^{wgt} and M^{act}, a two-dimensional grid search can be performed on memory budgets M^{wgt} and M^{act}. The candidates of M^{wgt} and M^{act} are given by uniformly assigning bit-width vectors b^{w} and b^{a} in the candidate bit width set B, such that the maximum number of feasible bit-width pairs for a given n is | [symbol] |ⁿ. The | [symbol] |²ⁿ search space represented by problem (7) is significantly reduced to at most 2|B|ⁿ⁺² by decoupling problem (7) into the two problems (8) and (9).

In at least some applications, the nature of the discrete nonconvex and non-linear optimization problem presented above makes a precise solution to the problem (5) not possible. However, the multi-part problem solution approach described above guarantees that [symbol] (b^{w}, b^{a}, n)≤min( [symbol] (θ.θ,0) [symbol] (bₑ^{w}, bₑ^{a}, N)), where (0,0,0) is the CLOUD-ONLY solution and (bₑ^{w}, bₑ^{a}, N) is the EDGE-ONLY Solution.

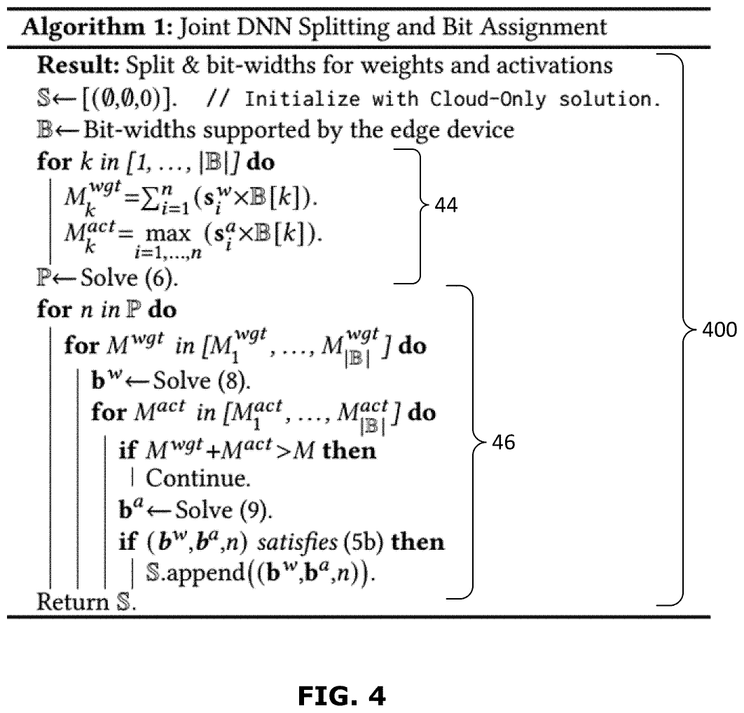

The actions of operations 44 and 46 are represented in the pseudocode 400 of FIG. 4.

Referring FIG. 2, once the list S of feasible solution tuples (b^{w}, b^{a}, n) is generated, a select, configure and deploy operation 48 can be performed. For example, the splitting solution that minimizes latency and satisfies the accuracy drop threshold constraint can be selected as an implementation solution from the list.

Once an implementation solution has been selected, a set of configuration actions can be applied to generate: (i) Edge DNN configuration information 33 that defines edge DNN 30 (corresponding to the first n layers of optimized trained DNN 12); and (ii) Cloud DNN configuration information 34 that defines could DNN 40 (corresponding to the last N-n layers of optimized trained DNN 12). In example embodiments, the Edge DNN configuration information 33 and Cloud DNN configuration information 34 could take the form of respective DAGs that include the information required for the edge device 88 to implement edge DNN 30 and for the cloud device 86 to implement cloud DNN 40. In examples, the weights included in Edge DNN configuration information 33 will be quantized versions of the weights from the corresponding layers in optimized trained DNN 12, as per the selected bit-width vector b^{w}. Similarly, the edge DNN configuration information 34 will include the information required to implement the selected feature map quantization bit-width vector b^{a}. In at least some examples, the Cloud DNN configuration information 34 will include information that specifies the same bit-widths as used for the last N-n layers of optimized trained DNN 12. However, it is also possible that the weight and feature map bit-widths for cloud DNN 40 could be different than those used in optimized trained DNN 12.

In example embodiments, a packing interface function 36 can be added to edge DNN 30 that is configured to organize and pack the feature map 39 output by the final layer of the edge DNN 30 so it can be efficiently transmitted through network 84 to cloud device 86. Similarly, a corresponding un-packing interface function 38 can be added to cloud DNN 40 that is configured to un-pack and organize the received feature map 39 and provide it to first layer of the cloud DNN 40. Further interface functions can be included to enable the inference result generated by cloud device 86 to be transmitted back to edge device 88 if desired.

In example embodiments the trained DNN 12 may be a DNN that is configured to perform inferences in respect of an input image.

Splitting module 10 is configured to treat splitting point and bit-width selection (i.e., quantization precision) as an optimization in which the goal is to identify the split and the bit-width assignment for weights and activations, such that the overall latency for the resulting split DNN (i.e. the combination of the edge and cloud DNNs) is reduced without sacrificing the accuracy. This approach has some advantages over existing strategies such as being secure, deterministic, and flexible in architecture. The proposed method provides a range of options in the accuracy-latency trade-off which can be selected based on the target application requirements. The bit-widths used throughout the different network layers can vary, allowing for mixed-precision quantization through the edge DNN 30. For example, an 8-bit integer bit-width could be assigned for the weights and feature values used for a first set of one or more layers in the edge DNN 30, followed by a second set of one or more layers followed by an 4-bit integer bit-width for the weights and feature values for a second set of one or more layers in the edge DNN 30, with a 16-bit floating point bit width being used for layers in the cloud DNN 40.

Although the splitting module 10 has been described above in the context of edge devices 88 and cloud devices 86 in the context of the Internet, the splitting module 10 can be applied in other environments in which deep learning models for performing inference tasks are divided between asymmetrical computing platforms. For example, in an alternative environment, edge device 88 may take the form of a weak micro-scale edge device (e.g. smart glasses, fitness tracker), cloud device 86 may take the form of a relatively more powerful device such as a smart phone, and the network 84 could be in the form of a Bluetooth™ link.

Referring to FIGS. 1 to 3, the performance splitting module 10 according to an example of the present disclosure can be summarized as follows. Splitting module 10 is configured to split a trained neural network (e.g., optimized DNN 12) into a first neural network (e.g., edge DNN 30) for execution on a first device (e.g., edge device 88) and a second neural network (e.g., cloud DNN 40) for execution on a second device (e.g., could device 86). Splitting module 10 identifies a first set of one or more neural network layers from the trained neural network for inclusion in the first neural network and a second set of one or more neural network layers from the trained neural network for inclusion in the second neural network. Splitting module 10 then assigns weight bit-widths for weights that configure the first set of one or more neural network layers and feature value bit-widths for feature maps that are generated by the first set of one or more neural network layers. The identifying and the assigning are performed to optimize, within an accuracy constraint, an overall latency of: the execution of the first neural network on the first device to generate a feature map output based on input data, transmission of the feature map output from the first device to the second device, and execution of the second neural network on the second device to generate an inference output based on the feature map output from the first device.

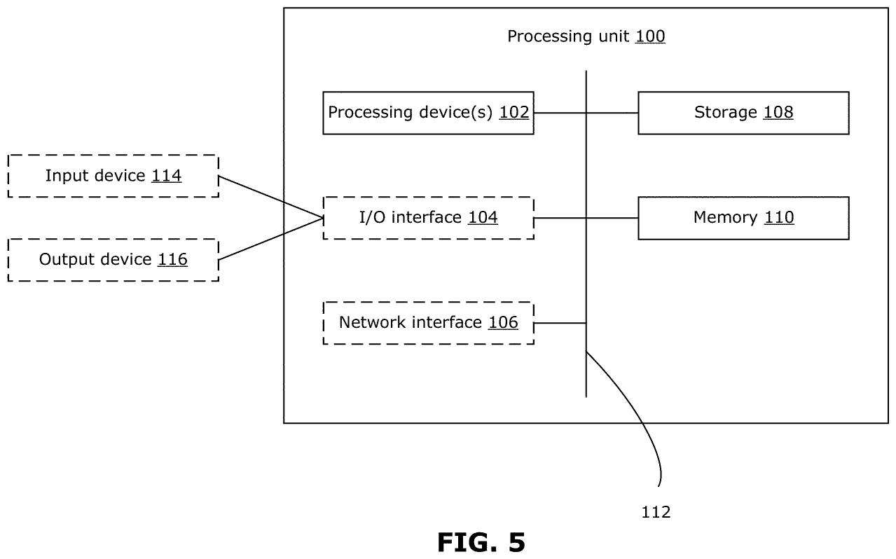

FIG. 5 is a block diagram of an example simplified processing unit 100, which may be part of a system or device that implements splitting module 10, or as edge device 88 that implements edge DNN 30, or as a cloud device 86 that implements cloud DNN 40, in accordance with examples disclosed herein. Other processing units suitable for implementing embodiments described in the present disclosure may be used, which may include components different from those discussed below. Although FIG. 5 shows a single instance of each component, there may be multiple instances of each component in the processing unit 100.

The processing unit 100 may include one or more processing devices 102, such as a processor, a microprocessor, an application-specific integrated circuit (ASIC), a field-programmable gate array (FPGA), or combinations thereof. The one or more processing devices 102 may also include other processing units (e.g. a Neural Processing Unit (NPU), a tensor processing unit (TPU), and/or a graphics processing unit (GPU)).

Optional elements in FIG. 5 are shown in dashed lines. The processing unit 100 may also include one or more optional input/output (I/O) interfaces 104, which may enable interfacing with one or more optional input devices 114 and/or optional output devices 116. In the example shown, the input device(s) 114 (e.g., a keyboard, a mouse, a microphone, a touchscreen, and/or a keypad) and output device(s) 116 (e.g., a display, a speaker and/or a printer) are shown as optional and external to the processing unit 100. In other examples, one or more of the input device(s) 114 and/or the output device(s) 116 may be included as a component of the processing unit 100. In other examples, there may not be any input device(s) 114 and output device(s) 116, in which case the I/O interface(s) 104 may not be needed.

The processing unit 100 may include one or more optional network interfaces 106 for wired (e.g. Ethernet cable) or wireless communication (e.g. one or more antennas) with a network (e.g., an intranet, the Internet, a P2P network, a WAN and/or a LAN).

The processing unit 100 may also include one or more storage units 108, which may include a mass storage unit such as a solid-state drive, a hard disk drive, a magnetic disk drive and/or an optical disk drive. The processing unit 100 may include one or more memories 110, which may include a volatile or non-volatile memory (e.g., a flash memory, a random access memory (RAM), and/or a read-only memory (ROM)). The non-transitory memory(ies) 110 may store instructions for execution by the processing device(s) 102 to implement an NN, equations, and algorithms described in the present disclosure to quantize and normalize data, and approximate one or more nonlinear functions of activation functions. The memory(ies) 110 may include other software instructions, such as implementing an operating system and other applications/functions.

In some other examples, one or more data sets and/or modules may be provided by an external memory (e.g., an external drive in wired or wireless communication with the processing unit 100) or may be provided by a transitory or non-transitory computer-readable medium. Examples of non-transitory computer-readable media include a RAM, a ROM, an erasable programmable ROM (EPROM), an electrically erasable programmable ROM (EEPROM), a flash memory, a CD-ROM, or other portable memory storage.

There may be a bus 112 providing communication among components of the processing unit 100, including the processing device(s) 102, optional I/O interface(s) 104, optional network interface(s) 106, storage unit(s) 108 and/or memory(ies) 110. The bus 112 may be any suitable bus architecture, including, for example, a memory bus, a peripheral bus or a video bus.

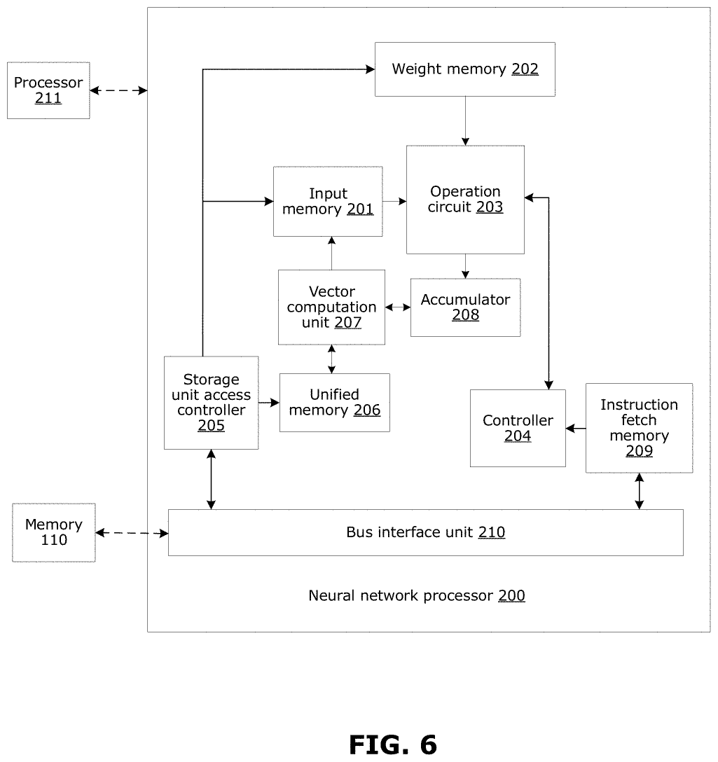

FIG. 6 is a block diagram illustrating an example hardware structure of an example NN processor 200 of the processing device 102 to implement a NN (such as could DNN 40 or edge DNN 30) according to some example embodiments of the present disclosure. The NN processor 200 may be provided on an integrated circuit (also referred to as a computer chip). All the algorithms of the layers and their neurons of a NN, including the piecewise linear approximation of nonlinear function, and quantization and normalization of data, may be implemented in the NN processor 200.

The processing device(s) 102 (FIG. 1) may include a further processor 211 in combination with NN processor 200. The NN processor 200 may be any processor that is applicable to NN computations, for example, a Neural Processing Unit (NPU), a tensor processing unit (TPU), a graphics processing unit (GPU), or the like. The NPU is used as an example. The NPU may be mounted, as a coprocessor, to the processor 211, and the processor 211 allocates a task to the NPU. A core part of the NPU is an operation circuit 203. A controller 204 controls the operation circuit 203 to extract matrix data from memories (201 and 202) and perform multiplication and addition operations.

In some implementations, the operation circuit 203 internally includes a plurality of processing units (Process Engine, PE). In some implementations, the operation circuit 203 is a bi-dimensional systolic array. Besides, the operation circuit 203 may be a uni-dimensional systolic array or another electronic circuit that can implement a mathematical operation such as multiplication and addition. In some implementations, the operation circuit 203 is a general matrix processor.

For example, it is assumed that there are an input matrix A, a weight matrix B, and an output matrix C. The operation circuit 203 obtains, from a weight memory 202, weight data of the matrix B and caches the data in each PE in the operation circuit 203. The operation circuit 203 obtains input data of the matrix A from an input memory 201 and performs a matrix operation based on the input data of the matrix A and the weight data of the matrix B. An obtained partial or final matrix result is stored in an accumulator (accumulator) 208.

A unified memory 206 is configured to store input data and output data. Weight data is directly moved to the weight memory 202 by using a storage unit access controller 205 (Direct Memory Access Controller, DMAC). The input data is also moved to the unified memory 206 by using the DMAC.

A bus interface unit (BIU, Bus Interface Unit) 210 is used for interaction between the DMAC and an instruction fetch memory 209 (Instruction Fetch Buffer). The bus interface unit 210 is further configured to enable the instruction fetch memory 209 to obtain an instruction from the memory 110, and is further configured to enable the storage unit access controller 205 to obtain, from the memory 110, source data of the input matrix A or the weight matrix B.

The DMAC is mainly configured to move input data from memory 110 Double Data Rate (DDR) to the unified memory 206, or move the weight data to the weight memory 202, or move the input data to the input memory 201.

A vector computation unit 207 includes a plurality of operation processing units. If needed, the vector computation unit 207 performs further processing, for example, vector multiplication, vector addition, an exponent operation, a logarithm operation, or magnitude comparison, on an output from the operation circuit 203. The vector computation unit 207 is mainly used for computation at a neuron or a layer (described below) of a neural network. Specifically, it may perform processing on computation, quantization, or normalization. For example, the vector computation unit 207 may apply a nonlinear function of an activation function or a piecewise linear function to an output matrix generated by the operation circuit 203, for example, a vector of an accumulated value, to generate an output value for each neuron of the next NN layer.

In some implementations, the vector computation unit 207 stores a processed vector to the unified memory 206. The instruction fetch memory 209 (Instruction Fetch Buffer) connected to the controller 204 is configured to store an instruction used by the controller 204.

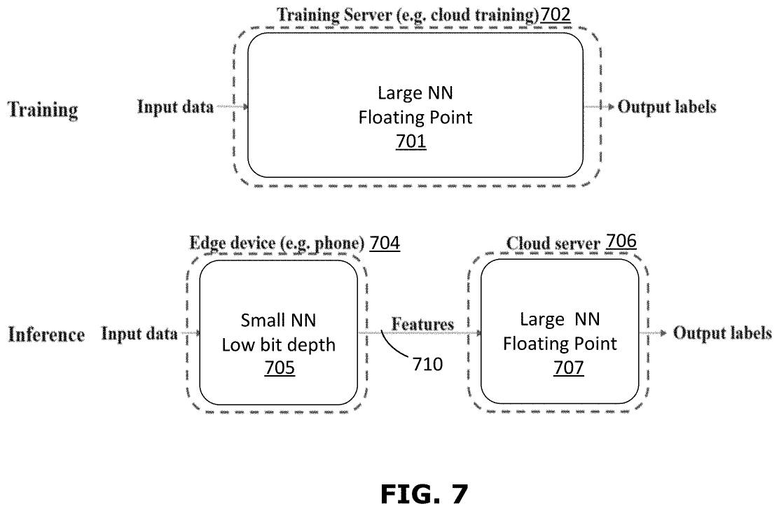

The unified memory 206, the input memory 201, the weight memory 202, and the instruction fetch memory 209 are all on-chip memories. The data memory 110 is independent of the hardware architecture of the NPU. With reference to FIG. 7, a further examples for dividing a fully trained neural network (NN) into multiple partitions that that can be executed on different computing platforms will now be described.

With reference to FIG. 7, further examples for dividing a fully trained neural network (NN) into multiple partitions that that can be executed on different computing platforms will now be described. Variables names and notation in equations (10) to (19) may be assigned different meanings and different terminology used for similar components in the following portion of the disclosure than those used above.

In examples, the desired bit-widths (also referred to as bit-depths) for weights and feature maps are used both in training and inference so that the behavior of the NN is not changed. In examples, the NN partitions are selected arbitrarily, to find an optimal balance between the workload (computer instructions involved when executing the deep learning model) performed at the edge device and the cloud device, and the amount of data that is transmitted between the edge device and the cloud device.

More specifically, workload intensive parts of the NN can be included in the NN partition performed on a cloud device to achieve a lower overall latency. For example, a large, floating point NN 701 that has been trained using a training server 702 can be partitioned into a small, low bit depth, NN 705 for deployment on a lower power computational device (e.g., edge device 704) and a larger, floating point, NN 707 for deployment on a higher powered computational device (e.g., cloud server 706). Features (e.g., a feature map) that are generated by the edge NN 705 based on input data are transmitted through a network 710 to the cloud server 706 for further inference processing by cloud NN 701 to generate output labels. Different Bit-depth assignment can be used to account for the differences in computational resources between edge device 704 and cloud server 706. This framework implemented by splitting module 700 is suitable for multi-task models as well as single-task models, and can be applied to any model structure and can use mixed precision. For example, instead of using float32 bit weights/operations for the entire NN inference, the NN partition (edge NN 705) allocated to edge device 704 can store/perform in lower bit depths such as int8 or int4. Further, support for devices/chips that can run only int8 (or lower) and have low memory footprint. In example embodiments, training is end-to-end. Therefore, in case of cascaded models there is no need for multiple iterations of data gathering, cleaning, labeling, and training. Only the final output labels are sufficient to train and end-to-end model. Moreover, in contrast to the cascaded models, the intermediate parts of the end-to-end model are trained to help optimize the overall loss. This can likely improve the overall accuracy.

For example, consider the example of license plate recognition. Traditional approaches use a two-stage training in that a detector neural network is trained to learn a model to detect license plates in images and a recognizer neural network is trained to learn a model to perform recognition of the license plates detected by the detector neural network. In the present disclosure, one model can perform both detection and recognition of license plates, and the detection network is learned in a way that maximizes the recognition accuracy. Neural networks in our method can also have mixed precision weights and activations to provide an efficient inference on the edge and the cloud. It is secure as it doesn't transmit the original data directly. The intermediate features can't be reverted back to the original data. The amount of data transmission is much lower than the original data size, as features are rich and concise in information. It is a deterministic approach. Once a model is trained, the separation, and the edge-cloud workload distribution remains unchanged. It is practical for many applications such as models for smartphones, surveillance cameras, IoT devices, etc. The application can be in computer vision, speech recognition, NLP, and basically anywhere a neural network is used at the edge.

In one example embodiment, end-to-end mixed precision training is performed at training server 702. For example, part of the NN 701 (e.g., a first subset of NN layers) is trained using 8 bits (integer) bit-depths for weights and features, and part of the NN 701 (e.g., a second subset of NN layers) is trained using 32 bits (float) bit-depths for weights and features. The NN 701 is then partitioned so that the small bit-depth trained part is implemented in as edge NN 705 and the large bit-depth trained part is implemented as cloud NN 707. This allows the NN workload to be split between the edge device 704 and the cloud server 706.

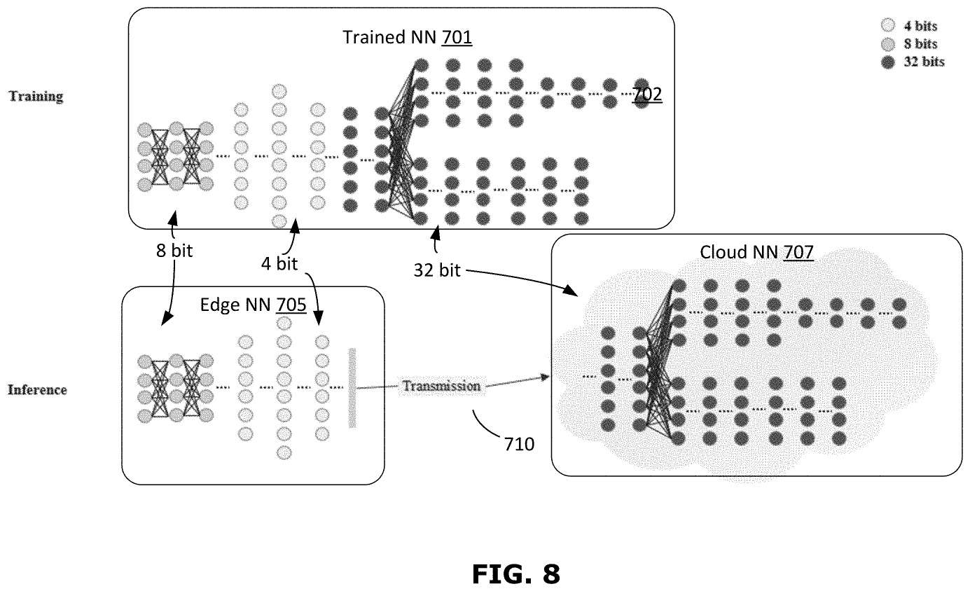

In a further example, represented in FIG. 8 during end-to-end mixed precision training, a first part of the NN 701 (e.g., a first subset of NN layers) is trained using 8 bits (integer) bit-depths for weights and features, a second subset part of the NN 701 (e.g., a second subset of NN layers) is trained using 4 bits (integer) bit-depths for weights and features, and a third part of the NN 701 (e.g., a third subset of NN layers) is trained using 32 bits (float) bit-depths for weights and features. NN 701 is then partitioned so that the first and second parts (8 bit and 4 bit parts) are assigned to edge NN 705 and the third part (32 bits) is assigned to cloud NN 707. The 4 bit features result in lower volume of transmitted data.

To identify the split and bit-width assignment numerical values for a given neural network 701, a computer program is run offline (only once). This program takes the characteristics of the edge device 705 (memory, cpu, etc.) and neural network 701 as input, and outputs the split and bit-widths.

In the case that a neural network 701 has Lₜₒₜₐₗ layers (Lₜₒₜₐₗ=L+L_{cloud}), the first L layers of the neural network 701 are deployed as edge network 705 on the edge device 704 (e.g., the instructions of the software program that includes the Lₜₒₜₐₗ layers of the neural network 701 are stored in memory of the edge device and the instructions are executed by a processor of the edge device 704) and the rest of the layers of the neural network 701 (L_{cloud} layers) are deployed as cloud NN 707 on a cloud computing platform (e.g. the instructions of the software program that includes the L_{cloud} layers of the neural network are stored in memory of one or more virtual machines instantiated by the cloud computing platform (e.g., cloud server 706) and the instructions are executed by processors of the virtual machines). In this case, L=0 means the entire model runs on the cloud, and L_{cloud}=0 would mean that the model runs on the edge device. Since the piece running on the cloud will be hosted on a GPU, it is run at a high bit-width, for example 16 bit FP (floating point) or 32 bit FP. In this setting, our goal is to identify a reasonable value for L as well as a suitable bit-width for every layer l=1,2, . . . , L, such that the overall latency is lower than the two extreme cases: 1) running entirely on the edge (L_{cloud}=0, if it fits in the device memory), or 2) transmission to the cloud, then execution there (L=0).

In the case that a model can't run entirely on the edge device 704 (e.g., doesn't fit or is too slow), the object of the system of FIG. 7 is to provide a solution that satisfies:

[symbol]

_{cloud}≥ [symbol] _{proposed} (10)

Where [symbol] _{cloud} and [symbol] _{proposed} denote the overall latency for the cloud and proposed method, respectively. If the model fits on the edge device, but has a higher latency then the cloud, the target of (10) still holds. In the case that edge latency is lower than the cloud, a solution in (10) is found that yields lower latency than the edge, otherwise defaults to the inference on the edge. That being said, (10) can be rewritten as:

[symbol]

ᵢₙₚᵤₜ^{tr}+ [symbol] ₁₆⁰+ . . . + [symbol] ₁₆^{L}+ [symbol] ₁₆^{L+1}+ . . . + [symbol] ₁₆ ^{L}^{ₜₒₜₐₗ}≥ [symbol] _{B}_{₀}⁰+ . . . + [symbol] _{B}_{_{L}}^{tr}+ [symbol] ₁₆^{L+1+ . . . +} [symbol] ₁₆^{L}^{ₜₒₜₐₗ} (11)

Where [symbol] _{B}_{ᵢ}ⁱ is the latency for layer i with bit-width Bᵢ, [symbol] ᵢₙₚᵤₜ^{tr} put is the time it takes to transmit the input to the cloud, and [symbol] _{B}_{_{L}}^{tr} is the transmission latency for the features of layer L with bit-width B_{L}. Note that it is reasonably assumed that the cloud model runs at 16 bit FP, but this can be changed to 32 bit FP as well. (11) can be simplified to:

[symbol]

ᵢₙₚᵤₜ^{tr}+ [symbol] ₁₆⁰+ . . . + [symbol] ₁₆^{L}≥ [symbol] _{B}_{₀}⁰+ . . . + [symbol] _{B}_{_{L}}^{L}+ [symbol] _{B}_{_{L}}^{tr} (12)

The overall optimization problem can then be formulated as:

$${arg max}_{{B}_{i} , L} ( {ℒ}_{input}^{tr} , {ℒ}_{{B}_{L}}^{tr} ) + ( {ℒ}_{16}^{0} + … + {ℒ}_{16}^{L} ) - ( {ℒ}_{{B}_{0}}^{0} + … + {ℒ}_{{B}_{L}}^{L} ) s . t . \\ {\sum }_{i = 1}^{L} ( {S}^{{W}_{i}} \times {B}^{{W}_{i}} ) + {max}_{i} ( {S}^{{A}_{i}} \times {B}^{{A}_{i}} ) \leq {M}_{total} \qquad ( 13 )$$

Where B^{W}^{ᵢ} and B^{A}^{ᵢ} are bit-width values assigned to weights and activations of layer i, S^{W}^{ᵢ} and S^{A}^{ᵢ} are the sizes of weights and activations, and Mₜₒₜₐₗ denotes the total memory available on the edge device. The constraint in (13) ensures that running the first L layers on the edge doesn't exceed the total available device memory. Note that in hardware, “read-only” memory stores the parameters (weights), and “read-write” memory stores the activations (as they change according to input data). Due to reuse of the “read-write” memory, activations memory slots are reused, but weights do get accumulated in memory. Therefore, the memory needed for the largest activation layer is taken into account in (13). As such,

$${M}_{max}^{activation} = {max}_{i} ( {S}^{{A}_{i}} \times {B}^{{A}_{i}} )$$

is the maximum memory required for activations.

For a fixed value of L, [symbol] ᵢₙₚᵤₜ^{tr} and ( [symbol] ₁₆⁰+ . . . + [symbol] ₁₆^{L}) become constants in (13). The optimization then turns into minimization of running the first L layers on edge plus the features transmission cost, i.e.

$${arg min}_{{B}_{i}} [ {ℒ}_{{B}_{L}}^{tr} + ( {ℒ}_{{B}_{0}}^{0} + … + {ℒ}_{{B}_{L}}^{L} ) ] .$$

Solutions with lowest latency are generally the ones with lower bit-widths values. However, low bit-width values increase the output quantization error, which in turn lowers the accuracy of the quantized model. That means only the solutions that provide low enough output quantization error are of interest. This has been an implicit constraint all along, as the goal of post-training quantization is to gain speed-ups without losing accuracy. Therefore, for the L layers running on the edge, the latency minimization problem can alternatively be thought of as a budgeted minimization of the output quantization errors, subject to memory and bit allocation constraints.

The case of a fixed L value will first be described, followed by an explanation of how this case fits in the overall solution provided by the system of FIG. 7. In the case of running a model entirely on edge device 704, (equivalent to a fixed value of L), demonstrated both empirically and theoretically that if the output quantization error is evaluated using Mean Squared Error (MSE), then the overall error is additive for weights and activations. In this formulation, the output quantization error is defined as:

$${arg min}_{{B}^{{W}_{i}} , {B}^{{A}_{i}}} {D}^{{W}_{1}} + {D}^{{A}_{1}} + … + {D}^{{W}_{L}} + {D}^{{A}_{L}} s . t . \\ {B}^{{W}_{1}} + {B}^{{A}_{1}} + … + {B}^{{W}_{L}} + {B}^{{A}_{L}} = {B}_{total} \qquad ( 14 )$$

Where B^{W}^{ᵢ} and B^{A}^{ᵢ} denote the bit-widths assigned to layer i weights and activations, Bₜₒₜₐₗ is the average total bit-width of the network, and D is the MSE output error (on feature vectors) resulted from quantizing weights or activations of a layer.

Example embodiments build on the formulation of (14) for the case of fixed L. However, instead of putting a constraint on the summation of bit-widths of different layers, an alternative more implementable constraint on the total memory is disclosed herein, which in turn relies on bit-widths values.

In the case of edge-cloud workload splitting, a two-dimensional problem arises where both bit-widths, B, and split, L, are unknown. This is a difficult problem to solve in closed form. Accordingly, the system of FIG. 7 is configured to make the search space is significantly smaller.

In example embodiments, training server 702 (or other device) is configured to first finding a reasonable splitting point. To this end, for average bit-width values in Bₜₒₜₐₗ=[2,4,6], all the solutions of (15) are identified:

$${B}_{A}^{*} = {arg min}_{{B}^{{A}_{i}}} {D}^{{A}_{1}} + … + {D}^{{A}_{{L}_{total}}} s . t . \\ {B}^{{A}_{1}} + … + {B}^{{A}_{{L}_{total}}} = {B}_{total} \qquad ( 15 )$$

To solve (15), Lagrange multipliers are incorporated. Equation (16) gives bit assignments per layer for “activations”. Once all possible solutions for various splits are found, they are sorted in the order of activations volume, as follows:

S*=sort(B_{A}*. activation_{size}−input_volume) (16)

Sorting is done in ascending order as the largest negative values are preferred. A large negative value in (16) means the activation volume for the corresponding layer is low, which in turn results in faster data transmission. S* provides a reasonable splitting and bit assignment to the first L layers activations. This assignment is reasonable, yet not optimal, as (15) was solved over Lₜₒₜₐₗ, not L.

However, simulations indicate that data transmission has a much more considerable impact in the overall latency than layer execution.

Next, bit-widths for the weights are identified by solving:

$${B}_{W}^{*} - {arg min}_{{B}^{{W}_{i}}} F ( {B}^{{W}_{i}} ) = {D}^{{W}_{1}} + … + {D}^{{W}_{L}} s . t . \\ {\sum }_{i = 1}^{L} {S}^{{W}_{i}} {B}^{{W}_{i}} \leq {M}_{total} - {M}_{max}^{activation} \qquad ( 17 )$$

where

$${M}_{max}^{activation} = {max}_{i} ( {S}^{{A}_{i}} {B}^{{A}_{i}} )$$

is calculated based on S* solution of (16), and the constraint in (17) is the same as constraint of (13). For any λ≥0, the solution to the constrained problem of (17) is also a solution to the unconstrained problem of:

$${B}_{W}^{*} = {arg min}_{{B}^{{W}_{i}}} F ( {B}^{{W}_{i}} ) + λ {\sum }_{i = 1}^{L} {S}^{{W}_{i}} {B}^{{W}_{i}} \qquad ( 18 )$$

(18) can be solved in the same way as (15) using a generalized Lagrange multiplier method for optimum allocation of resources.

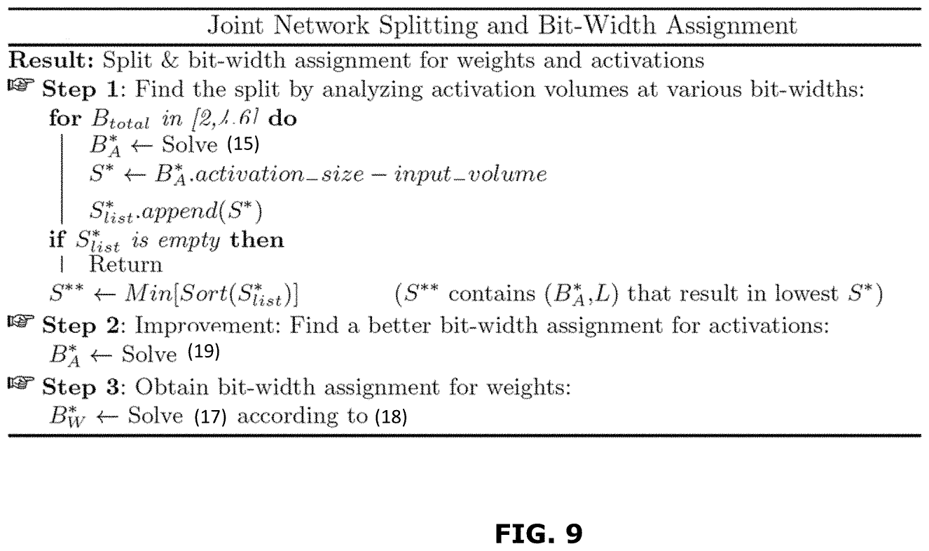

The pseudocode algorithm of FIG. 9 summaries the proposed method implemented by the System of FIG. 7. The second step in the algorithm of FIG. 9 includes a refinement to B^{A}^{ᵢ} solution found in (15). As mentioned above, solutions provided by (15) in the first iteration, are sub-optimal. It is possible to obtain better solutions for B^{A}^{ᵢ}, by solving:

$${B}_{A}^{*} = {arg min}_{{B}^{{A}_{i}}} {D}^{{A}_{1}} + … + {D}^{{A}_{L}} s . t . \\ {max}_{i = 1 , … , L - 1} {S}^{{A}_{i}} {B}^{{A}_{i}} \leq {M}_{max}^{activation} \qquad ( 19 )$$

Note that the constraint now has changed to reflect the maximum memory available for the activations (which is now known). Solving (19) likely results in higher bit-width values for some of the layers in l=1,2, . . . , L. This in turn means a lower MSE value, higher accuracy, at the expense of likely negligible latency increase. That being said, a simple but fast way to achieve a reasonable solution, is to start bumping up the bit-width values for the layers, until their volume reaches just below Mₘₐₓ^{activation}.

The proposed methods disclosed above are in principle applicable to any neural network for any task. In other words, they provides solutions for splitting an NN network to two piece to run on different platforms. Trivial solutions can be running the model entirely on one platform or the other. If available, an alternative solution is to run parts of the model on each platform. That being said, the later case is more likely to happen when the edge device has scarce amount of computation resource (limitations on power, memory, or speed). Examples include low-power embedded devices, smart watches, smart glasses, hearing aid devices, etc. It is worth noting that even though deep learning specialized chips are entering the markets, but to a large extent the majority of existing cost-friendly consumer products are feasible scenarios to consider here.

An example application of the present disclosure is now described. In license plate recognition, consider an on-chip camera mounted on an object (e.g., a gate) in a parking lot that is to authorize the entry of certain vehicles with registered license plates. The input to the camera system are frames captured from cars and the output should be the recognized license plates (as character strings).

For the edge device, a realistic consumer camera based on Hi3516E V200 SoC is chosen. This is an economical HD IP camera, and is widely used for home surveillance, and can connect to the cloud. The chip features an ARM Cortex-A7, with low memory and storage.

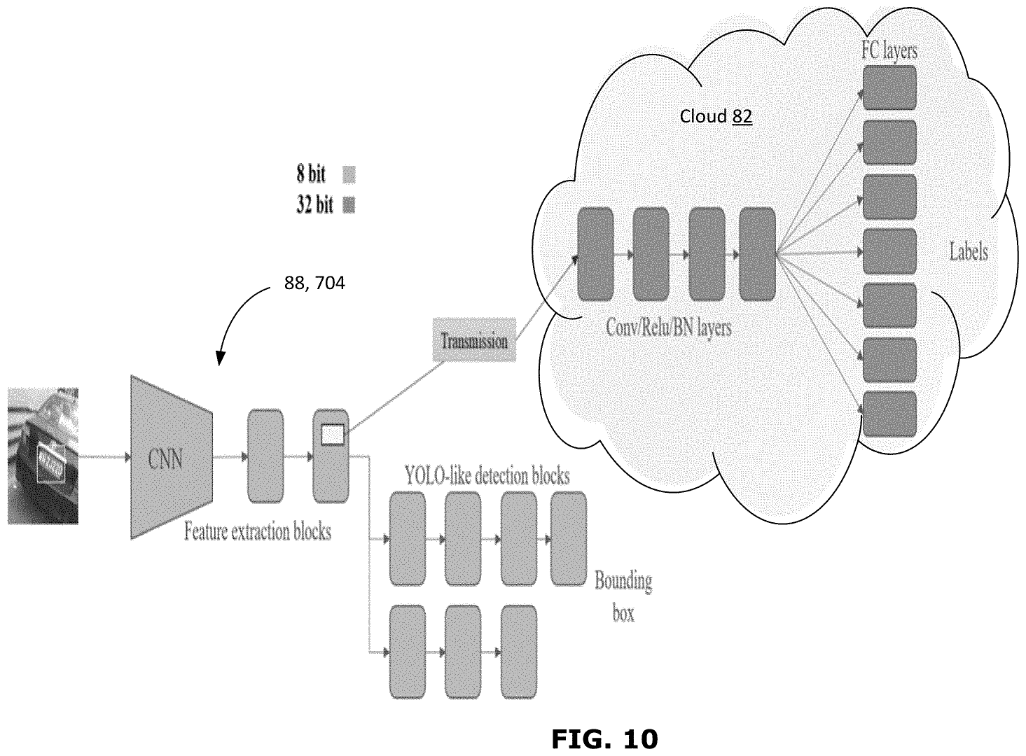

FIG. 10 shows a block-diagram of the proposed solution. As shown in FIG. 10, the system of the present disclosure ensures enough workload for the camera chip of an edge device 88 or 704, and securely transmits features (the only data that is needed, nothing extra) to a cloud device in the cloud 82 for accurate recognition. In other words, the edge-cloud workload separation results it the edge device 88 or 704 transmitting features (not the original data), which results in the protection of the privacy of the user's data. The mixed precision separable model that divides the workload between the edge device 88, 704 and cloud 82 has can provide a high accuracy (as it can utilize a larger neural network with higher learning capacity than an edge-only solution), and lower latency (as it pushes the heavy workload to a cloud 82 GPU).

The present disclosure may be embodied in other specific forms without departing from the subject matter of the claims. The described example embodiments are to be considered in all respects as being only illustrative and not restrictive.

Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices, and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

The units described as separate parts may or may not be physically separate, and parts displayed as units may or may not be physical units, may be located in one position, or may be distributed on a plurality of network units. Some or all of the units may be selected according to actual requirements to achieve the objectives of the solutions of the embodiments.

In addition, functional units in the example embodiments may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of this disclosure essentially, or the part contributing to the prior art, or some of the technical solutions may be implemented in a form of a software product. The software product is stored in a storage medium and includes several instructions for instructing a computer device (which may be a personal computer, a server, or a network device) to perform all or some of the steps of the methods described in the embodiments of this application. The foregoing storage medium includes any medium that can store program code, such as a universal serial bus (USB) flash drive, a removable hard disk, a read-only memory (ROM), a random access memory (RAM), a magnetic disk, or an optical disc, among others.

The foregoing descriptions are merely specific implementations but are not intended to limit the scope of protection. Any variation or replacement readily figured out by a person skilled in the art within the technical scope shall fall within the scope of protection. Therefore, the scope of protection shall be subject to the protection scope of the claims.

1. A method for splitting a trained neural network into a first neural network for execution on a first device and a second neural network for execution on a second device, comprising:
identifying a first set of one or more neural network layers from the trained neural network for inclusion in the first neural network and a second set of one or more neural network layers from the trained neural network for inclusion in the second neural network; and
assigning weight bit-widths for weights that configure the first set of one or more neural network layers and feature map bit-widths for feature maps that are generated by the first set of one or more neural network layers;
the identifying and the assigning being performed to optimize, within an accuracy constraint, an overall latency of: the execution of the first neural network on the first device to generate a feature map output based on input data, transmission of the feature map output from the first device to the second device, and execution of the second neural network on the second device to generate an inference output based on the feature map output from the first device.

2. The method of claim 1 wherein the identifying and the assigning comprise:
selecting, from among a plurality of potential splitting solutions for splitting the trained neural network into the first set of one or more neural network layers and the second set of one or more neural network layers, a set of one or more feasible solutions that fall within the accuracy constraint, wherein each feasible solution identifies: (i) a splitting point that indicates the layers from the trained neural network that are to be included in the first set of one or more layers; (ii) a set of weight bit-widths for the weights that configure the first set of one or more neural network layers; and (iii) a set of feature map bit-widths for the feature maps that are generated by the first set of one or more neural network layers.

3. The method of claim 2 comprising selecting an implementation solution from the set of one or more feasible solutions; generating, in accordance with the implementation solution, first neural network configuration information that defines the first neural network and second neural network configuration information that defines the second neural network; and providing the first neural network configuration information to the first device and the first second neural network configuration information to the second device.

4. The method of claim 2 wherein the selecting is further based on a memory constraint for the first device.

5. The method of claim 4 comprising, prior to the selecting the set of one or more feasible solutions, determining the plurality of potential splitting solutions is based on identifying transmission costs associated with different possible splitting points that are lower than a transmission cost associated with having all layers of the trained neural network included in the second neural network.

6. The method of claim 2 wherein the selecting comprises:
computing quantization errors for the combined performance of the first neural network and the second neural network for different weight bit-widths and feature map bit-widths for each of the plurality of potential solutions, wherein the selecting the set of one or more feasible solutions is based on selecting weight bit-widths and feature map bit-widths that result in computed quantization errors that fall within the accuracy constraint.

7. The method of claim 6 wherein the different weight bit-widths and feature map bit-widths for each of the plurality of potential solutions are uniformly selected from sets of possible weight bit-widths and feature map bit-widths, respectively.

8. The method of claim 1 wherein the accuracy constraint comprises a defined accuracy drop tolerance threshold for combined performance of the first neural network and the second neural network relative to performance of the trained neural network.

9. The method claim 1 wherein the first device has lower memory capabilities than the second device.

10. The method of claim 1 wherein the first device is an edge device and the second device is a cloud based computing platform.

11. The method of claim 1 wherein the trained neural network is an optimized trained neural network represented as a directed acyclic graph.

12. The method of claim 1 wherein the first neural network is a mixed-precision network comprising at least some layers that have different weight and feature map bit-widths than other layers.

13. A computer system comprising one or more processing devices and one or more non-transient storages storing computer implementable instructions for execution by the one or more processing devices, wherein execution of the computer implementable instructions configures the computer system to perform a method for splitting a trained neural network into a first neural network for execution on a first device and a second neural network for execution on a second device, comprising:
identifying a first set of one or more neural network layers from the trained neural network for inclusion in the first neural network and a second set of one or more neural network layers from the trained neural network for inclusion in the second neural network; and
assigning weight bit-widths for weights that configure the first set of one or more neural network layers and feature map bit-widths for feature maps that are generated by the first set of one or more neural network layers;
the identifying and the assigning being performed to optimize, within an accuracy constraint, an overall latency of: the execution of the first neural network on the first device to generate a feature map output based on input data, transmission of the feature map output from the first device to the second device, and execution of the second neural network on the second device to generate an inference output based on the feature map output from the first device.

14. The computer system of claim 13 wherein the identifying and the assigning comprise:
selecting, from among a plurality of potential splitting solutions for splitting the trained neural network into the first set of one or more neural network layers and the second set of one or more neural network layers, a set of one or more feasible solutions that fall within the accuracy constraint, wherein each feasible solution identifies: (i) a splitting point that indicates the layers from the trained neural network that are to be included in the first set of one or more layers; (ii) a set of weight bit-widths for the weights that configure the first set of one or more neural network layers; and (iii) a set of feature map bit-widths for the feature maps that are generated by the first set of one or more neural network layers.

15. The computer system of claim 14 wherein the method comprises selecting an implementation solution from the set of one or more feasible solutions; generating, in accordance with the implementation solution, first neural network configuration information that defines the first neural network and second neural network configuration information that defines the second neural network; and providing the first neural network configuration information to the first device and the first second neural network configuration information to the second device.

16. The computer system of claim 15 wherein the method comprises, prior to the selecting the set of one or more feasible solutions, determining the plurality of potential splitting solutions is based on identifying transmission costs associated with different possible splitting points that are lower than a transmission cost associated with having all layers of the trained neural network included in the second neural network.

17. The computer system of claim 14 wherein the selecting comprises:
computing quantization errors for the combined performance of the first neural network and the second neural network for different weight bit-widths and feature map bit-widths for each of the plurality of potential solutions, wherein the selecting the set of one or more feasible solutions is based on selecting weight bit-widths and feature map bit-widths that result in computed quantization errors that fall within the accuracy constraint.

18. The computer system of claim 17 wherein the different weight bit-widths and feature map bit-widths for each of the plurality of potential solutions are uniformly selected from sets of possible weight bit-widths and feature map bit-widths, respectively.

19. The computer system of claim 13 wherein the accuracy constraint comprises a defined accuracy drop tolerance threshold for combined performance of the first neural network and the second neural network relative to performance of the trained neural network.

20. A non-transient computer readable medium storing computer implementable instructions that configured to a computer system to perform a method for splitting a trained neural network into a first neural network for execution on a first device and a second neural network for execution on a second device, comprising:
identifying a first set of one or more neural network layers from the trained neural network for inclusion in the first neural network and a second set of one or more neural network layers from the trained neural network for inclusion in the second neural network; and
assigning weight bit-widths for weights that configure the first set of one or more neural network layers and feature map bit-widths for feature maps that are generated by the first set of one or more neural network layers;
the identifying and the assigning being performed to optimize, within an accuracy constraint, an overall latency of: the execution of the first neural network on the first device to generate a feature map output based on input data, transmission of the feature map output from the first device to the second device, and execution of the second neural network on the second device to generate an inference output based on the feature map output from the first device.
